(19) United States
(12) Patent Application Publication
(10) Pub. No.: US 2016/0264842 A1
(43) Pub. Date: Sep. 15, 2016

(54) SETTABLE COMPOSITIONS AND USES THEREOF

(71) Applicant: HALLIBURTON ENERGY SERVICES, INC., Houston, TX (US)

(72) Inventors: Matthew Lynn Miller, Spring, TX (US); Donald L. Whitfill, Kingwood, TX (US)

(21) Appl. No.: 15/031,145

(22) PCT Filed: Feb. 26, 2014
(86) PCT No.: PCT/US14/18742

§ 371 Date: Apr. 21, 2016

(51) Int. Cl. C09K 8/508; E21B 33/14; C09K 8/467

(52) U.S. Cl. CPC C09K 8/5083; C09K 8/467; E21B 33/14; C09K 2208/08

(57) ABSTRACT

Various embodiments disclosed related to a composition for treating a subterranean formation, and methods and systems including the same. In various embodiments, the present invention provides a method of treating a subterranean formation that can include obtaining or providing a sealant composition comprising an alkali-swellable latex and a viscosifying agent. The method also includes placing the composition in a subterranean formation downhole.

### BACKGROUND OF THE INVENTION

This invention relates to the field of sealant compositions and more specifically to sealant compositions comprising alkali-swellable latex and a viscosifying agent, as well as methods for using such compositions to treating a subterranean formation (e.g., a wellbore).

Natural resources such as gas, oil, and water residing in a subterranean formation or zone are usually recovered by drilling a wellbore down to the subterranean formation while circulating a drilling fluid in the wellbore. The drilling fluid is usually circulated downward through the interior of a drill pipe and upward through the annulus, which is located between the exterior of the drill pipe and the walls of the wellbore. After terminating the circulation of the drilling fluid, a string of pipe, e.g., casing, is run in the wellbore. Next, primary cementing is sometimes performed whereby a cement slurry is placed in the annulus and permitted to set into a hard mass (e.g., sheath) to thereby attach the casing string of pipe to the walls of the wellbore and seal the annulus. Subsequent secondary cementing operations may also be performed. One example of a secondary cementing operation is squeeze cementing whereby a cement slurry is employed to plug and seal off undesirable flow passages around the cement sheath and/or the casing. While a cement slurry is one type of sealant composition used in primary and secondary cementing operations, other non-cement containing sealant compositions may also be employed.

Latex emulsions, which contain a stable water-insoluble, polymeric colloidal suspension in an aqueous solution, are commonly used in sealant compositions to improve the properties of those compositions. For example, latex emulsions are used in cement compositions to reduce the loss of fluid therefrom and to reduce the gas flow potential of the composition as the compositions are being pumped to the annulus. Latex emulsions are also employed to reduce the brittleness of the sealant compositions; otherwise, the compositions may shatter under the impacts and shocks generated by drilling and other well operations. Such sealant compositions may be used for sealing the junction of multilateral wells. In addition, latex emulsions are used to improve the flexibility of sealant compositions.

Moreover, latex emulsions are also mixed with drilling fluids, particularly the non-aqueous type, forming a “pill” that may be applied to a loss-circulation zone such as natural or induced fractures, thereby forming solid masses for sealing those zones to prevent the drilling fluids from being lost during drilling.

Drawbacks to using latex emulsions, alone, include a lack of sufficient strength and elasticity. For instance, sealant compositions containing latex emulsions may be unable to withstand fluid pressures imposed upon the emulsion by drilling operations. Further, previous attempts to set or solidify alkali-swellable latex creates, instead, a rubbery mass lacking the strength necessary to act as, among other things, a pill that may be used as a lost circulation material (LCM). Therefore, there are needs for a settable latex composition having increased resistance to downhole fluid pressures.

### SUMMARY OF THE INVENTION

In various embodiments, the present composition and method can have certain advantages over other compositions and methods for treating a subterranean formation, at least some of which are unexpected. For example, the compositions described herein facilitate the preparation of a single, settable latex-based pill that may be used as a lost circulation material (LCM) that can be pumped down the drill pipe to a loss zone by either the drilling rig pumps or a cementing unit. Other types of latex pills require either multiple tandem pills of a water base pH buffering solution, or a dual pill—one pumped down the drill pipe by a cementing unit and the other pumped down the drill pipe/casing and drill pipe/formation annulus with the rig pumps.

In various embodiments, the present invention provides a method of treating a subterranean formation. Some embodiments related to a method comprising obtaining or providing a sealant composition comprising an alkali-swellable latex and a viscosifying agent; placing the sealant composition in a subterranean formation; and heating the sealant composition at a temperature and for a time sufficient to solidify the sealant composition.

Other embodiments relate to a method of treating a subterranean formation, the method comprising placing a sealant composition comprising an alkali-swellable latex and a viscosifying agent in a subterranean formation; and heating the sealant composition at a temperature and for a time sufficient to solidify the treatment fluid.

Still other embodiments relate to a sealant composition for treatment of a subterranean formation, the composition comprising an alkali-swellable latex and a viscosifying agent, wherein the sealant composition solidifies upon sufficient heating.

And other embodiments relate to a method for solidifying a sealant composition comprising an alkali-swellable latex and a viscosifying agent, in the absence of an added pH-increasing material, comprising heating the sealant composition at a temperature and for a time sufficient to solidify the sealant composition.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

In one embodiment, the invention relates to a sealant composition comprising an alkali-swellable latex and a viscosifying agent. The sealant composition is a mixture that solidifies upon heating the sealant composition at a temperature and for a time sufficient to solidify the sealant composition in wellbore zones where a fluid (e.g., drilling fluid) is being lost. For instance, the sealant composition solidifies in a loss-circulation zone and thereby restores circulation. The solidified mixture can set into a flexible, resilient and tough material, which may prevent further fluid losses when circulation is resumed.

The sealant compositions of the various embodiments of the present invention can contain other components, including suitable additives. Examples of suitable additives include fluid absorbing materials, particulate materials, non-alkali- swellable latexes, acids or combinations thereof. In an alternative embodiment, the sealant composition is a compressible sealant composition comprising foaming surfactants and foam stabilizing surfactants.

In some embodiments, the sealant composition may be used in a wellbore that penetrates a subterranean formation. As used herein, the term “subterranean formation” encompasses both areas below exposed earth and areas below earth covered by water such as ocean or fresh water. The sealant composition can be used for any purpose. For instance, the sealant composition can be used to service the wellbore. Without limitation, “servicing the wellbore” includes positioning the sealant composition in the wellbore to isolate the subterranean formation from a portion of the wellbore; to support a conduit in the wellbore; to plug a void or crack in the conduit; to plug a void or crack in a cement sheath disposed in an annulus of the wellbore; to plug an opening between a cement sheath and the conduit; to prevent the loss of aqueous or non-aqueous drilling fluids into loss circulation zones such as a void, vugular zone, or fracture; to be used as a fluid in front of cement slurry in cementing operations; and to seal an annulus between the wellbore and an expandable pipe or pipe string.

As used herein, the term “alkali-swellable latex” broadly refers to a latex emulsion that, when exposed to pH-increasing materials, may swell and exhibit an increase in viscosity. Such pH-increasing materials may be present and/or added to the latex emulsion, but need not be added to the selant compositions of the various embodiments of the present invention.

In some embodiments, the alkali-swellable latexes contain, in addition to the typical latex forming monomers, monomers having acidic groups (e.g., carboxylic acid functional groups) capable of reacting with a pH-increasing material thereby forming anionic pendant groups on the polymer back bone. Alkali-swellable latex emulsions having acidic groups have a pH in the range of from about 2 to about 8 and are can be low viscosity fluids with viscosities less than about 100 cP for an emulsion containing about 30% solids. When the pH is increased by the addition of a pH-increasing material, the viscosity increase may be in the range of from about five times to more than about a million times for a 30% emulsion. In contrast to alkali-swellable latexes, conventional latex emulsions do not significantly increase in viscosity upon the addition of a pH-increasing material.

In some embodiments, alkali- swellable latexes may be cross-linked during the polymerization phase of the monomers. Examples of typical latex forming monomers that may be used to make alkali-swellable latexes include, without limitation, vinyl aromatic monomers (e.g., styrene based monomers), ethylene, butadiene, vinylnitrile (e.g., acrylonitrile), olefinically unsaturated esters of C₁-C₈ alcohols, or combinations thereof. In some embodiments, non-ionic monomers that exhibit steric effects and that contain long ethoxylate or hydrocarbon chains (e.g., C₁₀-C₃₀ hydrocarbon chains; C₁₀-C₂₀ hydrocarbon chains; and C₁₂-C₁₈ hydrocarbon chains) may also be present. The monomers containing acid groups capable of reacting with pH-increasing materials include, but are not limited to, ethylenically unsaturated monomers containing at least one carboxylic acid functional group. Such carboxylic acid containing monomers may be present in the range of from about 5 to about 30% by weight, about 5 to about 20% by weight, about 10 to about 30% by weight or about 15 to about 30% by weight of the total monomer composition used in preparing an alkali-swellable latex. Without limitation, examples of such carboxylic acid containing groups include acrylic acid; alkyl acrylic acids, such as methacrylic acid and ethacrylic acid; alpha-chloro-acrylic acid; alpha-cyano acrylic acid; alpha-chloro-methacrylic acid; alpha-cyano methacrylic acid; crotonic acid; alpha-phenyl acrylic acid; beta-acryloxy propionic acid; sorbic acid; alpha-chloro sorbic acid; angelic acid; cinnamic acid; p-chloro cinnamic acid; beta-styryl acrylic acid (1-carboxy-4-phenyl butadiene-1,3); itaconic acid; maleic acid; citraconic acid; mesaconic acid; glutaconic acid; aconitic acid; fumaric acid; tricarboxy ethylene, or combinations thereof. In an embodiment, the carboxylic acid containing groups can include itaconic acid, acrylic acid, or combinations thereof.

The preparation of alkali-swellable latexes is well-known in the art. See, e.g., U.S. Pat. Nos. 3,793,244; 4,861,822; and 5,563,201, which are incorporated herein by reference in their entirety.

In some embodiments, the sealant composition includes an alkali-swellable latex comprising a hydrophobically-modified carboxylated styrene-butadiene copolymer (block or random), a styrene/butadiene/acrylic copolymer (block or random) or itaconic acid terpolymer latex emulsion prepared by, e.g., emulsion polymerization. The emulsion can be a colloidal dispersion of the copolymer. The colloidal dispersion includes water from about 40 to about 70% by weight of the emulsion. In addition to the dispersed copolymer, the alkali-swellable latex may include an emulsifier, polymerization catalysts, chain modifying agents, emulsion stabilizing agents, resins, crosslinking agents, and the like.

Without limitation, examples of suitable commercially available alkali-swellable latexes include TYCHEM® 3000 (Mallard Creek Polymers Inc., Charlotte, N.C.), TYCHEM® 68710 (Mallard Creek Polymers Inc., Charlotte, N.C.); ACRYSOL™ TT 615 (The Dow Chemical Company, Midland, Mich.); SN THICKENERs 618, 929, AM-1, and 640 (San Nopco Korea); ALCOGUM® SL-70 (Akzo Nobel, Chicago, Ill.); HEURASE (The Dow Chemical Company, Midland, Mich.); ADCOTE™ 37-220 (The Dow Chemical Company, Midland, Mich.); and JETSIZE AE-75 (Eka Chemicals/Akzo Nobel). TYCHEM® 3000 is a hydrophobically-modified carboxylated styrene-butadiene copolymer suspended in a 32% to 36% by weight aqueous emulsion. TYCHEM® 68710 is a carboxylated styrene/butadiene copolymer suspended in a 45% to 55% by weight aqueous emulsion. JETSIZE AE-75 is a styrene acrylate emulsion.

Any suitable amount of alkali-swellable latex may be used to prepare the sealant composition of the various embodiments of the present invention. Examples of amounts of alkali-swellable latex that may be used to prepare the sealant composition of the various embodiments of the present invention range from about 200 lbm/bbl to about 700 lbm/bbl, about 200 lbm/bbl to about 500 lbm/bbl, about 300 lbm/bbl to about 700 lbm/bbl or about 300 lbm/bbl to about 500 lbm/bbl.

In some embodiments, the alkali-swellable latex may contain crosslinking agents that are suitable for facilitating the formation of a resilient rubbery mass, which may be used during the polymerization stage of the monomers or added to the latex prior to use (for example to the sealant composition). In embodiments wherein the alkali-swellable latex contains vulcanizable groups such as the diene type of monomers, crosslinking agents including vulcanizing agents such as sulfur, 2,2′-dithiobisbenzothiazole, organic peroxides, azo compounds, alkylthiuram disulfides, selenium phenolic derivatives and the like; vulcanization accelerators such as fatty acids (e.g., stearic acid), metallic oxides (e.g., zinc oxide), aldehyde amine compounds, guanidine compounds, disulfide thiuram compounds, and the like; vulcanization retarders such as salicylic acid, sodium acetate, phthalic anhydride and N-cyclohexyl thiophthalimide; defoamers; or combinations thereof may be added just prior to use, for instance to a sealant composition. See, e.g., U.S. Pat. No. 5,293,938, which is incorporated by reference herein in its entirety. If the crosslinking agent is used during production of the latex, it may be a multifunctional monomer with more than one polymerizable group for example divinylbenzene, trimethylolpropane triacrylate, tetraethyleneglycol diacrylate, methylene bisacrylamide and the like.

When the alkali-swellable latex comprises crosslinking agents, the crosslinking agents may be present from about 0.1 to about 5 wt. % by weight of the monomers, alternatively from about 0.2 to about 1 wt. % crosslinking agents by weight of the monomers.

In some embodiments, the sealant composition further comprises a pH-increasing material that comprises a base-producing material. A base-producing material includes any compound capable of generating hydroxyl ions (OH⁻) in water to react with or neutralize an acid to form a salt. In one embodiment, the base-producing material has at least partial solubility in water, for example a solubility of 1% or greater in water. Examples of suitable base-producing materials include without limitation ammonium, alkali and alkali earth metal carbonates and bicarbonates, alkali and alkali earth metal hydroxides, alkali and alkali earth metal oxides, alkali and alkali earth metal phosphates and hydrogen phosphates, alkali and alkaline earth metal sulphides, alkali and alkaline earth metal salts of silicates and aluminates, water soluble or water dispersible organic amines, polymeric amines, amino alcohols, or combinations thereof.

Without limitation, examples of suitable alkali and alkali earth metal carbonates and bicarbonates include Na₂CO₃, K₂CO₃, CaCO₃, MgCO₃, NaHCO₃, KHCO₃. It is to be understood that when carbonate and bicarbonate salts are used as base-producing material, a byproduct may be carbon dioxide, which may enhance the mechanical properties of a non-cement based sealant composition.

Examples of suitable alkali and alkali earth metal hydroxides include without limitation NaOH, NH₄OH, KOH, LiOH, and Mg(OH)₂.

Examples of suitable alkali and alkali earth metal oxides include without limitation BaO, SrO, Li₂O, CaO, Na₂O, K₂O, and MgO.

Examples of suitable alkali and alkali earth metal phosphates and hydrogen phosphates include without limitation Na₃PO₄, Ca₃(PO₄)₂, CaHPO₄, and KH₂PO₄.

Examples of suitable alkali and alkaline earth metal sulphides include without limitation Na₂S, CaS, SrS, and the like.

Suitable silicate salts include without limitation sodium silicate, potassium silicate and sodium metasilicate.

Examples of suitable aluminate salts include without limitations sodium aluminate and calcium aluminate. Examples of commercial silicates include FLO-CHEK® and ECONOLITE® (Halliburton Energy Services, Inc.).

Examples of commercial alkali metal aluminates include sodium aluminate available as VERSASET (Halliburton Energy Services, Inc.).

Examples of organic amines include without limitation polymeric amines, monomeric amines containing one or more amine groups, and oligomeric amines. The organic amines may be completely or partially soluble in water. The organic amines may also be dissolved in an organic fluid such as those used as base oils in non-aqueous drilling fluids such as hydrocarbons and esters. Examples of suitable water soluble or water dispersible amines include triethylamine, aniline, dimethylaniline, ethylenediamine, diethylene triamine, cyclohexylamine, diethyltoluene diamine, 2,4,6-tri- dimethylaminomethylphenol, isophoroneamine, and the like. Commercial examples of the organic amines include STRATALOCK™ D, STRATALOCK™ E, and STRATALOCK™ B (Halliburton Energy Services, Inc.); JEFFAMINE® (Huntsman Corp., Austin, Tex.); and EH-101, EH-102, EH-103 and EH-104 (Applied Poleramic, Bernicia, Calif.). In an embodiment, the organic amine is dissolved in a non-aqueous fluid, for example a drilling fluid, and contacted with the composition containing a alkali-swellable latex of the various embodiments of the present invention. Examples of suitable polymeric amines include chitosan, polylysine, poly(dimethylaminoethylmethacrylate), poly(ethyleneimine), poly(vinylamine-co-vinylalcohol), poly(vinylamine) and the like. Commercial examples of poly(ethyleneimine) include LUPAMIN® (BASF AG Corporation, Ludwigshafen, Germany). Commercial examples of chitosan include CHITOCLEAR™ (Primex/Vanson Halosource, Redmond, Va.). Formylated poly(vinylamine)s are commercially available from BASF AG Corporation as LUPAMIN®, for example LUPAMIN® 1500.

Examples of amino alcohols include ethanolamine, triethanolamine, tripropanolamine and the like.

The base-producing material, when present in the sealant compositions of certain embodiments of the present invention, may be present in an amount sufficient to provide a sealant composition having a pH of from about 7 to about 14, from about 8 to about 13 or from about 9 to about 13. It is to be understood that the base-producing material can include other components that produce a base when reacted together.

In some embodiments, the pH-increasing material, such as a base-producing compound, can be encapsulated with at least one encapsulating material so as to delay, among other things, the formation of a higher viscosity swollen latex product.

The base-producing material can be in any suitable form including in liquid form (e.g., an aqueous solution or an organic liquid) or solid form. If the base-producing material comprises an aqueous solution, it may be encapsulated in a particulate porous solid material. The particulate porous solid material comprises any suitable material that remains dry and free flowing after absorbing the aqueous solution and through which the aqueous solution slowly diffuses. Examples of particulate porous solid materials include, but are not limited to, diatomaceous earth, zeolites, silica, expanded perlite, alumina, metal salts of alumino-silicates, clays, hydrotalcite, styrene divinylbenzene based materials, cross-linked polyalkylacrylate esters, cross-linked modified starches, natural and synthetic hollow fibers, porous beads (e.g., perlite beads), or combinations thereof. If the base producing material is an organic liquid, it may also be encapsulated in hydrophobically modified porous silica in addition to the afore-mentioned absorbents.

In alternative embodiments, encapsulation further includes an external coating of a polymer material through which an aqueous solution diffuses and that is placed on the particulate porous solid material. Examples of external coatings include but are not limited to EDPM rubber, polyvinyldichloride, nylon, waxes, polyurethanes, cross-linked partially hydrolyzed acrylics, cross-linked latex, styrene-butadiene rubber, cross-linked polyurethane and combinations thereof. See, e.g., U.S. Pat. Nos. 5,373,901; 6,527,051; 6,554,071; and 6,209,646, which are incorporated by reference herein in their entirety.

In some embodiments, the sealant compositions or pH-increasing materials of the embodiments described herein, comprise cement, including hydraulic cements. Without limitation, examples of suitable hydraulic cements include Portland cements (e.g., classes A, C, G, and H Portland cements), pozzolana cements, gypsum cements, phosphate cements, high alumina content cements, silica cements, high alkalinity cements, Magnesia cements, and combinations thereof. Suitable median cement particle sizes are in the 1 to 200 microns range, alternatively 5 to 150 microns, and alternatively 10 to 120 microns range. See, e.g., U.S. Patent No. 8,383,558, which is incorporated herein by reference in its entirety. The cement compositions can contain, among other things, fluids (e.g., water; salt water in the form of an unsaturated aqueous salt solution or a saturated aqueous salt solution such as brine or seawater; and non-aqueous fluids, including diesel and kerosene); cement surfactants (e.g., imidazole fatty acid condensates and salts of dodecybenzene sulfonic acid); and other additives, including, but not limited to densifying materials, light weight additives such as hollow glass or ceramic beads, fly ashes, fumed silica, defoamers, set retarders, set accelerators, and combinations thereof.

In some embodiments, the sealant composition of various embodiments of the present invention can comprise fluid absorbing materials such as organophilic clay, water swellable clay, a water absorbing mineral, an oil absorbing mineral, or combinations thereof. Without limitation, examples of organophilic clays include alkyl quaternary ammonium bentonite clay, vermiculite, and hydrophobically modified porous precipitated silica. When present, the amount of organophilic clay present in the sealant composition may be in a range of from about 0.3% to about 30% by weight of the composition. Examples of suitable water swellable clays include but are not limited to montmorillonite clays such as bentonite, attapulgite, Fuller's earth, porous precipitated silica, expanded perlite and vermiculite and combinations thereof. When present, the amount of water swellable clay present in the sealant composition may be in a range of from about 5% to about 60% by weight of the composition.

In some embodiments, the sealant compositions of the various embodiments of the present invention can comprises particulate materials. As used herein, the term “particulate material(s)” refers to any particles having the physical shape of platelets, shavings, fibers, flakes, ribbons, rods, strips, spheroids, toroids, pellets, tablets, or any other physical shape. The particulate materials may be included in the sealant composition to improve its mechanical properties such as tensile strength, compressive strength, resilience, rigidity, flexibility, and the like. Examples of suitable particulate materials include, but are not limited to, mineral particles, thermoset polymer laminate particles, graphitic carbon-based particles, ground battery casings, ground tires, ground nut shells (e.g., walnut shells, peanut shells, and almond shells), sized-calcium carbonate particles, petroleum coke particles, vitrified shale particles, calcium clay particles, glass particles, mica particles, ceramic particles, polymeric beads, synthetic fibers (e.g., polypropylene fibers), glass fibers, mineral fibers (e.g., basalt, wollastonite, and sepiolite), cellulosic fibers (e.g., viscose cellulosic fibers) and combinations thereof.

Sufficient amounts of particulate materials may be added to the sealant composition to improve the effectiveness of the sealant composition of the various embodiments of the present invention in reducing or preventing circulation losses and withstanding increased pressures. In certain embodiments, the particulate materials may be present in the sealant composition in amounts between about 5% to 35% by weight of the sealant composition.

In some embodiments, the concentration of particulates in the sealant composition may be expressed in pounds per barrel (“ppb”) and may be greater than about 0.01, 0.05 ppb, 0.1 ppb, 0.5 ppb, 1 ppb, 3 ppb, 5 ppb, 10 ppb, 25 ppb, 50 ppb, 100 ppb or 200 ppb to an upper limit of less than about 200 ppb, 150 ppb, 100 ppb, 75 ppb, 50 ppb, 25 ppb, 10 ppb, 5 ppb, 4 ppb, 3 ppb, 2 ppb, 1 ppb, or 0.5 ppb in the sealant composition, where the amount may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit. In some embodiments, the concentration of particulates in the sealant composition may range from about 0.01 ppb to about 50 ppb, about 0.1 ppb to about 20 ppb, about 0.5 ppb to about 10 ppb or about 0.5 ppb to about 5 ppb.

In some embodiments, the sealant compositions of the various embodiments of the present invention can comprises lost circulation materials (LCM). Examples of LCM include, but are not limited to BARACARB®, WALL-NUT®, BAROFIBER®, BDF-562, DUO-SQUEEZE® H, FUSE-IT™, HYDRO-PLUG®, STEEL SEAL®, and STOPPIT™, and combinations thereof, all of which are available from Halliburton Energy Services, Inc.

In some embodiments, the concentration of LCM in the sealant composition may be greater than about 1 ppb, 3 ppb, 5 ppb, 10 ppb, 25 ppb, 50 ppb, 100 ppb or 200 ppb to an upper limit of less than about 200 ppb, 150 ppb, 100 ppb, 75 ppb, 50 ppb, 25 ppb, 10 ppb, 5 ppb, 4 ppb, 3 ppb, or 2 ppb in the sealant composition, where the amount may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit. In some embodiments, the concentration of particulates in the sealant composition may range from about 1 ppb to about 100 ppb, about 10 ppb to about 80 ppb, about 40 ppb to about 60 ppb or about 40 ppb to about 80 ppb.

In some embodiments, a viscosifying agent is added to the sealant composition. Examples of suitable viscosifying agents include without limitation alginate, chitosan, curdlan, dextran, emulsan, a galactoglucopolysaccharide, gellan, glucuronan, N-acetyl-heparosan, hyaluronic acid, indicant, kefiran, lentinan, levan, mauran, pullulan, scleroglucan, schizophyllan, stewartan, succinoglycan, xanthan gum (e.g., BARAZAN® D powdered xanthan gum polymer; Halliburton Energy Services, Inc.), xylane, welan, starch, tamarind, tragacanth, guar gum, derivatized guar, gum ghatti, gum arabic, locust bean gum, diutan gum, cellulose, hydroxyethylcellulose, hemicellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Any suitable amount of viscosifying agent may be used to prepare the sealant composition of the various embodiments of the present invention. Examples of amounts of viscosifying agent that may be used to prepare the sealant composition of the various embodiments of the present invention range from about 0.5 lbm/bbl to about 50 lbm/bbl, about 1 lbm/bbl to about 20 lbm/bbl, about 1 lbm/bbl to about 10 lbm/bbl, about 1 lbm/bbl to about 5 lbm/bbl or about 1 lbm/bbl to about 2 lbm/bbl.

In an embodiment, the sealant composition may include a non-alkali-swellable latex. Without limitation, examples of non-alkali-swellable latexes include a latex comprising a styrene/butadiene copolymer latex emulsion or suitable elastomeric polymers in aqueous latex form, including aqueous dispersions or emulsions. Without limitation, examples of suitable elastomeric polymers include natural rubber (cis-1,4-polyisoprene), modified types thereof, synthetic polymers, and blends thereof. Without limitation, examples of suitable synthetic polymers include ethylene-acrylic acid ionomers. The ratio of alkali-swellable to non-alkali-swellable latex may be in the weight ratio of from about 5:95 to about 95:5.

In some embodiments, the sealant composition can include an acid. In some embodiments, the acid is any suitable organic acid including, but not limited to, benzoic acid, lactic acid, acetic acid, formic acid, citric acid, oxalic acid, uric acid, and the like or combinations thereof.

Any suitable amount of acid may be used to prepare the sealant composition of the various embodiments of the present invention. Examples of amounts of acid that may be used to prepare the sealant composition of the various embodiments of the present invention range from about 0.5 lbm/bbl to about 10 lbm/bbl, about 1 lbm/bbl to about 5 lbm/bbl, about 1 lbm/bbl to about 3 lbm/bbl or about 1 lbm/bbl to about 2 lbm/bbl.

Additives such as defoamers may be added to prevent foaming during mixing. Additives for achieving the desired density such as hollow beads or high density materials such as haemetite and barium sulfate may also be added to the sealant composition. Particulate dispersants such as sulfonated naphthalene formaldehyde condensate (e.g., CFR-2 from Halliburton Energy Services, Inc.), sulfite adducts of acetone-formaldehyde condensate (e.g., CFR-3® from Halliburton Energy Services, Inc.) or sulfonated melamine formaldehyde condensate may also be added.

The sealant compositions of the various embodiments of the present invention may be prepared in any suitable manner using either batch mixing the alkali- swellable latex and viscosifying agent, and other components of the composition, or on-the-fly procedures. In one example, the alkali- swellable latex and viscosifying agent may be mixed above-ground at a temperature ranging from about 40° F. to about 100° F., preferably from about 60° F. to about 80° F. The sealant compositions may be used immediately following preparation or stored at a temperature below a temperature that would be sufficient to solidify the sealant composition. A sealant composition thus prepared may then be displaced into a wellbore.

In another example, the alkali-swellable latex and viscosifying agent may be displaced into the wellbore via separate flowpaths. The two streams are allowed to mix downhole at a desired location and form a sealant composition. In one example, the viscosifying agent, optionally mixed in with a drilling fluid or in a separate inert carrier fluid (e.g., water), can be pumped down the annular wellbore space outside the drill pipe, and the alkali- swellable latex can be pumped down the drill pipe. The two streams are allowed to mix downhole at a desired location and form the sealant composition. In another example, the viscosifying agent, optionally mixed in with a drilling fluid or in a separate inert carrier fluid (e.g., water), can be pumped down a drill pipe, and the alkali-swellable latex can be pumped down an annular wellbore space outside the drill pipe in a separate stream. Again, the two streams are allowed to mix downhole at a desired location and form a sealant composition. Methods for introducing compositions into a wellbore to seal subterranean zones are described in U.S. Pat. Nos. 5,913,364; 6,167,967; and 6,258,757, which are incorporated by reference herein in their entirety. It is to be understood that drilling fluid includes any suitable drilling fluid such as oil based, water based, water, and the like.

In one embodiment, the sealant composition is introduced to the wellbore to prevent the loss of aqueous or non-aqueous drilling fluids into loss-circulation zones such as voids, vugular zones, and natural or induced fractures while drilling. In one example, viscosifying agent, optionally dissolved or suspended in drilling fluid, can be pumped into the wellbore separately from the alkali-swellable latex and allowed to mix with the alkali-swellable latex downhole to form a sealant composition near or inside, e.g., a loss-circulation zone. In the wellbore, the sealant composition is heated at a temperature and for a time sufficient to solidify the sealant composition near or inside, e.g., a loss-circulation zone. The solidified sealant composition plugs the zone and reduces or inhibits loss of subsequently pumped drilling fluid, which allows for further drilling. Additives can also be added to the viscosifying agent and drilling fluid (when present) and pumped into the wellbore.

In one embodiment, sealant compositions that include alkali-swellable latex and a viscosifying agent may be employed in well completion operations such as primary and secondary cementing operations. In primary cementing, a sealant composition may be displaced into an annulus of the wellbore and allowed to set such that it isolates the subterranean formation from a different portion of the wellbore. The sealant composition thus forms a barrier that prevents fluids in that subterranean formation from migrating into other subterranean formations. Within the annulus, the sealant composition also serves to support a conduit, e.g., casing, in the wellbore. In one example, the wellbore in which the sealant composition is positioned belongs to a multilateral wellbore configuration. It is to be understood that a multilateral wellbore configuration includes at least two principal wellbores connected by one or more ancillary wellbores. In secondary cementing, often referred to as squeeze cementing, the sealant composition may be strategically positioned in the wellbore to plug a void or crack in the conduit, to plug a void or crack in the solidified sealant composition, and so forth.

In another embodiment, the sealant composition containing alkali-swellable latex and a viscosifying agent, but otherwise no other cementitious materials, may be used in well completion operations such as primary operations. As an example, sealant composition may be placed behind expandable casings or used for consolidating gravel packs or incompetent formations. Further, such sealant compositions may be used in remedial operations such as sealing leaks, cracks, or voids and forming temporary plugs for the purpose of isolating zones to divert subsequent fluids and the like.

Once the sealant composition is a desired location (e.g., within a wellbore), the sealant composition is heated at a temperature and for a time sufficient to solidify the sealant composition near or inside the desired location (e.g., a loss-circulation zone). The heating required to solidify the sealant composition may be provided by the user or the heating may be provided by the environment near or inside the desired location within a subterranean formation where the composition is placed. The temperature at which the sealant composition may be heated to solidify the sealant composition may be any suitable temperature ranging from about 120° F. to about 300° F., from about 120° F. to about 200° F., from about 120° F. to about 180° F. or from about 120° F. to about 160° F. for a duration of time ranging from about 30 minutes to about 20 hours, about 1 hour to about 10 hours, about 2 hours to about 10 hours, about 2 hours to about 7 hours or about 2 to about 5 hours. In some embodiments, the sealant composition is considered solid or solidified when the sealant composition reaches a shear strength of from about 3,000 lb/100 ft² to about 30,000 lb/100 ft², a shear strength of about 3,000 lb/100 ft² to about 15,000 lb/100 ft², a shear strength of about 5,000 lb/100 ft² to about 15,000 lb/100 ft², a shear strength of about 10,000 lb/100 ft² to about 15,000 lb/100 ft², a shear strength of about 15,000 lb/100 ft² to about 25,000 lb/100 ft², or a shear strength of about 5,000 lb/100 ft² to about 10,000 lb/100 ft².

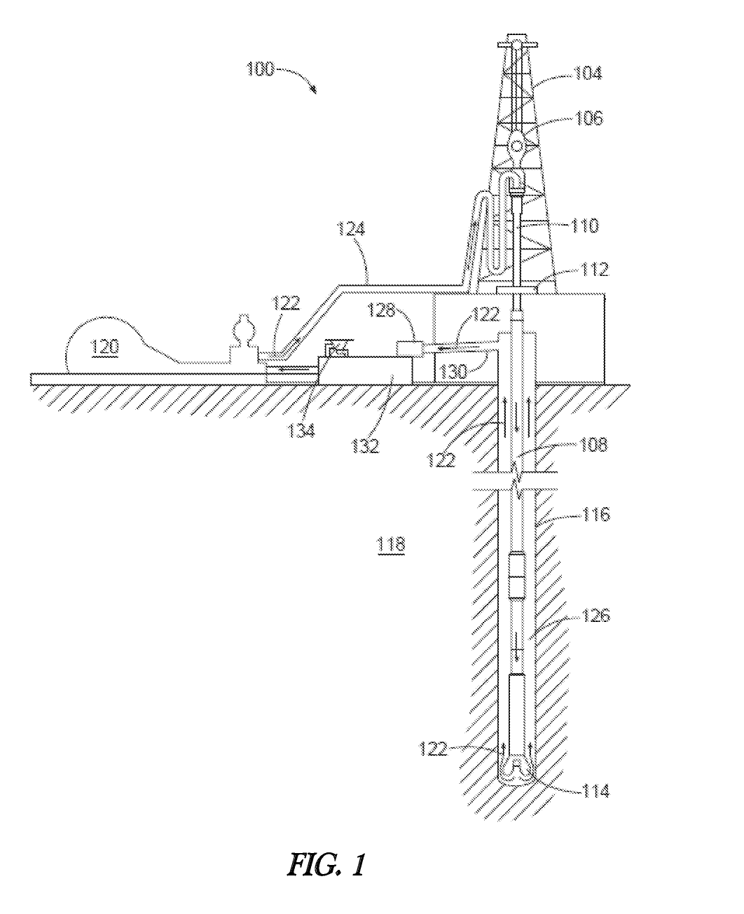

The sealant compositions disclosed herein may directly or indirectly affect one or more components or pieces of equipment associated with the preparation, delivery, recapture, recycling, reuse, and/or disposal of the disclosed sealant composition. For example, and with reference to FIG. 1, the disclosed sealant composition may directly or indirectly affect one or more components or pieces of equipment associated with a wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

The components of the sealant composition may be added to, among other things, a drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the sealant composition may be added to, among other things, a drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the sealant composition may be stored, reconditioned, and/or regulated until added to a drilling fluid 122.

As mentioned above, the sealant composition may directly or indirectly affect the components and equipment of the drilling assembly 100. For example, the sealant composition may directly or indirectly affect the fluid processing unit(s) 128, which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used to store, monitor, regulate, and/or recondition the sealant composition.

The sealant composition may directly or indirectly affect the pump 120, which representatively includes any conduits, pipelines, trucks, tubulars, and/or pipes used to fluidically convey the sealant composition downhole, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The sealant composition may also directly or indirectly affect the mixing hopper 134 and the retention pit 132 and their assorted variations.

The sealant composition may also directly or indirectly affect the various downhole equipment and tools that may come into contact with the sealant composition such as, but not limited to, the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The sealant composition may also directly or indirectly affect any downhole heat exchangers, valves and corresponding actuation devices, tool seals, packers and other wellbore isolation devices or components, and the like associated with the wellbore 116. The sealant composition may also directly or indirectly affect the drill bit 114, which may include, but is not limited to, roller cone bits, polycrystalline diamond compact (PDC) bits, natural diamond bits, any hole openers, reamers, coring bits, and the like.

While not specifically illustrated herein, the sealant composition may also directly or indirectly affect any transport or delivery equipment used to convey the sealant composition to the drilling assembly 100 such as, for example, any transport vessels, conduits, pipelines, trucks, tubulars, and/or pipes used to fluidically move the sealant composition from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

In various embodiments, the present invention provides a system. The system can be any suitable system that can use or that can be generated by use of the sealant composition described herein, or that can perform or be generated by performance of a method for using the sealant composition described herein. The system can include a composition including the sealant composition. The system can also include a subterranean formation including the sealant composition therein before, during or after the sealant composition solidifies. In some embodiments, the sealant composition in the system can also include at least one of an aqueous liquid, a downhole fluid, and a proppant.

In some embodiments, the system can include a tubular disposed in a wellbore. The system can include a pump configured to pump the composition downhole through the tubular and into the subterranean formation. In some embodiments, the system can include a subterranean formation including the composition therein.

In some embodiments, the system can include a drillstring disposed in a wellbore. The drillstring can include a drill bit at a downhole end of the drillstring. The system can include an annulus between the drillstring and the wellbore. The system can include a pump configured to circulate the composition through the drill string, through the drill bit, and back above-surface through the annulus. The system can further include a fluid processing unit configured to process the composition exiting the annulus to generate a cleaned drilling fluid for recirculation through the wellbore.

In various embodiments, the present invention provides an apparatus. The apparatus can be any suitable apparatus that can use or that can be generated by use of the sealant composition described herein in a subterranean formation, or that can perform or be generated by performance of a method for using the method for using the sealant composition described herein.

Various embodiments provide systems and apparatus configured for delivering the sealant composition described herein to a downhole location and for using the composition therein. In various embodiments, the systems can include a pump fluidly coupled to a tubular (e.g., any suitable type of oilfield pipe, such as pipeline, drill pipe, production tubing, and the like), the tubular containing a sealant composition described herein.

The pump can be a high pressure pump in some embodiments. As used herein, the term “high pressure pump” will refer to a pump that is capable of delivering a fluid downhole at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include, but are not limited to, floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the sealant composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery downhole.

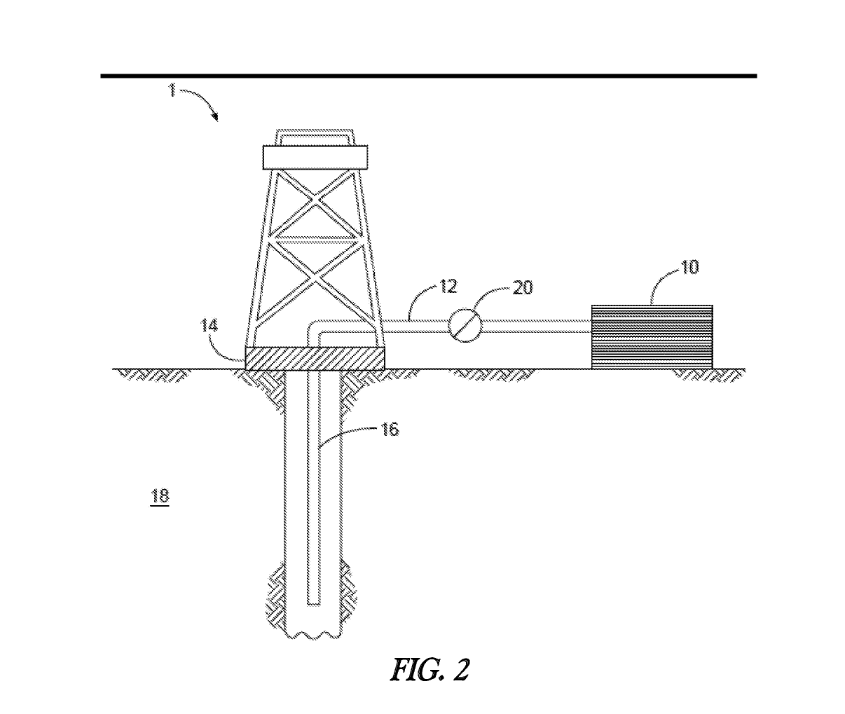

FIG. 2 shows an illustrative schematic of systems and apparatuses that can deliver sealant compositions of the present invention to a downhole location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the sealant composition. In some embodiments, the composition that has flowed back to wellhead 14 can subsequently be recovered, and in some examples reformulated, and recirculated to subterranean formation 18.

It is also to be recognized that the disclosed sealant composition can also directly or indirectly affect the various downhole equipment and tools that can come into contact with the composition during operation. Such equipment and tools can include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

Various embodiments provide a composition for treatment of a subterranean formation. The composition can be any suitable composition that can be used to perform an embodiment of the method for treatment of a subterranean formation described herein. For example, the composition can include an embodiment of the sealant composition described herein.

In various embodiments, the present invention provides a method for preparing a sealant composition for treatment of a subterranean formation. The method can be any suitable method that produces a composition described herein. For example, the method can include forming a composition including an embodiment of the sealant composition described herein.

### EXAMPLES

Various embodiments of the present invention can be better understood by reference to the following Example which is offered by way of illustration. The present invention is not limited to the Examples given herein.

### Example 1

The visocosifying agent BARAZAN® D PLUS powdered xanthan gum polymer (1.5 lb/bbl; Halliburton Energy Services, Inc.) was dispersed and hydrated into the alkali-swellably latex TYCHEM® 3000 (Mallard Creek Polymers Inc., Charlotte, N.C.). TYCHEM ® 3000 is one example of a hydrophobically-modified carboxylated styrene-butadiene copolymer. The resulting mixture is a viscous fluid at 70° F. for months, but begins to solidify after 3 hours at 120° F., and it solidifies after 1 hour at 150° F. Various combinations of lost circulation material (LCM) can be mixed into this combination (calcium carbonate causes the resulting mixture to foam at ambient pressure) resulting in higher shear strength formulations as shown in Table 2. The shear strength is also enhanced by the addition of citric acid, but the addition results in syneresis. The addition of cellulosic fibers, such as viscose cellulosic fibers, enhances the shear strength of a formulation. The addition of other LCM can also enhance the strength as shown in Table 2.

TABLE 1

| | TYCHEM ® | BARAZAN ® D | Citric | Viscose | |
|---|---|---|---|---|---|
| | 3000 | PLUS | acid | (3 mm; | Shear Strength |
| Material | (lb/bbl) | (lb/bbl) | (lb/bbl) | ppb) | (lb/100 ft²) |
| Formulation 1 | 350 | 1.5 | 0 | 0 | 3300 |
| Formulation 2 | 350 | 1.5 | 0 | 0.7 | 13690 |
| Formulation 3 | 350 | 1.75 | 1.5 | 0 | 5060 |
| Formulation 4 | 350 | 1.75 | 1.5 | 0.7 | 10260 |
| Formulation 5 | 350 | 1.5 | 0.5 | 0 | 10260 |
| Formulation 6 | 350 | 1.5 | 0.5 | 0.7 | 13690 |

TABLE 2

| | TYCHEM ® | BARAZAN ® | Citric | Viscose | | STOPPIT ™ | Shear |
|---|---|---|---|---|---|---|---|
| | 3000 | D PLUS | acid | (3 mm; | BDF-562 | (Halliburton | Strength |
| Material | (lb/bbl) | (lb/bbl) | (lb/bbl) | ppb) | (ppb) | (ppb)) | (lb/100 ft²) |
| Formulation 2 | 350 | 1.5 | 0 | 0.7 | 0 | 0 | 13690 |
| Formulation 6 | 350 | 1.5 | 0.5 | 0.7 | 0 | 0 | 13690 |
| Formulation 7 | 350 | 1.5 | 0 | 3.5 | 0 | 0 | 7734 |
| Formulation 8 | 350 | 1.5 | 0.5 | 3.5 | 0 | 0 | 20530 |
| Formulation 9 | 350 | 1.5 | 0 | 3.5 | 50 | 0 | 16451 |
| Formulation 10 | 350 | 1.5 | 0.5 | 3.5 | 50 | 0 | 20530 |
| Formulation 11 | 350 | 1.5 | 0 | 3.5 | 0 | 50 | 5864 |
| Formulation 12 | 350 | 1.5 | 0.5 | 3.5 | 0 | 50 | 5864 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

The following embodiments are provided, the numbering of which is not to be construed as designating levels of importance:

Embodiment 1 relates to a method comprising obtaining or providing a sealant composition comprising an alkali-swellable latex and a viscosifying agent; placing the sealant composition in a subterranean formation; and heating the sealant composition at a temperature and for a time sufficient to solidify the sealant composition.

Embodiment 2 relates to the method of Embodiment 1, wherein the sealant composition does not comprise an added pH-increasing material.

Embodiment 3 relates to the method of Embodiments 1-2, wherein the heating comprises heating the placed sealant composition at a temperature from about 120° F. to about 300° F.

Embodiment 4 relates to the method of Embodiments 1-3, wherein the time sufficient to solidify the sealant composition is from about 30 minutes to about 20 hours.

Embodiment 5 relates to the method of Embodiments 1-4, wherein the alkali-swellable latex comprises an ethylenically unsaturated monomer containing at least one carboxylic acid functional group.

Embodiment 6 relates to the method of Embodiment 5, wherein the ethylenically unsaturated monomer containing at least one carboxylic functional group is present in the sealant composition in the amount of from about 5 to about 30% by weight of the monomers used in preparing the alkali-swellable latex.

Embodiment 7 relates to the method of Embodiments 1-6, wherein the alkali-swellable latex comprises a vinyl aromatic monomer, an ethylene monomer, a butadiene monomer, a vinylnitrile monomer, an olefinically unsaturated ester of C1-C8 alcohol monomer, or combinations thereof.

Embodiment 8 relates to the method of Embodiments 1-7, wherein the alkali-swellable latex comprises hydrophobically-modified carboxylated styrene-butadiene copolymer.

Embodiment 9 relates to the method of Embodiments 1-8, wherein the alkali-swellable latex comprises from about 0.1 to about 5 wt. % of a crosslinking agent by weight of monomer.

Embodiment 10 relates to the method of Embodiments 1-9, wherein the viscosifying agent comprises at least one of alginate, chitosan, curdlan, dextran, emulsan, a galactoglucopolysaccharide, gellan, glucuronan, N-acetyl-heparosan, hyaluronic acid, indicant, kefiran, lentinan, levan, mauran, pullulan, scleroglucan, schizophyllan, stewartan, succinoglycan, xanthan gum, xylane, welan, starch, tamarind, tragacanth, guar gum, derivatized guar, gum ghatti, gum arabic, locust bean gum, diutan gum, cellulose, hydroxyethylcellulose, hemicellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Embodiment 11 relates to the method of Embodiments 1-10, wherein the sealant composition further comprises a pH-increasing material.

Embodiment 12 relates to the method of Embodiment 11, wherein the pH-increasing material comprises at least one of a base-producing material and a cement.

Embodiment 13 relates to the method of Embodiment 12, wherein the cement comprises a Portland cement, a pozzolana cement, a gypsum cement, a phosphate cement, a high alumina content cement, a silica cement, a high alkalinity cement, a magnesia cement, or combinations thereof.

Embodiment 14 relates to the method of Embodiment 12, wherein the pH-increasing material comprises a base-producing material, and wherein the base-producing material comprises alkali and alkali earth metal carbonates, alkali and alkali earth metal bicarbonates, alkali and alkali earth metal hydroxides, alkali and alkali earth metal oxides, alkali and alkali earth metal phosphates, alkali and alkali earth metal hydrogen phosphates, alkali and alkaline earth metal sulphides, alkali and alkaline earth metal salts of silicates, alkali and alkaline earth metal salts of aluminates, water soluble or water dispersible organic amines, polymeric amines, amino alcohols, or combinations thereof.

Embodiment 15 relates to the method of Embodiment 11, wherein the pH-increasing material comprises an encapsulated pH-increasing material.

Embodiment 16 relates to the method of Embodiments 1-15, wherein the sealant composition further comprises at least one of a fluid absorbing material, a particulate material, and a non-alkali-swellable latex.

Embodiment 17 relates to the method of Embodiments 1-16, wherein the sealant composition further comprises a fluid absorbing material, and wherein the fluid absorbing material comprises organophilic clay, water swellable clay, a water absorbing mineral, an oil absorbing mineral, or combinations thereof.

Embodiment 18 relates to the method of Embodiments 1-17, wherein the sealant composition further comprises a particulate material comprising cellulosic fibers.

Embodiment 19 relates to the method of Embodiments 1-18, wherein the sealant composition further comprises particulate materials in an amount between about 0.01 ppb to about 200 ppb of the sealant composition.

Embodiment 20 relates to the method of Embodiments 1-19, wherein the sealant composition further comprises at least one of a surfactant, a densifying material, a light weight additive, fly ash, fumed silica, a defoamer, a set retarder, and a set accelerator.

Embodiment 21 relates to the method of Embodiments 1-20, further comprising introducing a particulate material to the wellbore.

Embodiment 22 relates to the method of Embodiments 1-21, wherein the method comprises mixing the alkali-swellable latex and the viscosifying agent before the placing in the subterranean formation.

Embodiment 23 relates to the method of Embodiments 1-21, wherein the method comprises separately placing the alkali-swellable latex and the viscosifying agent in the subterranean formation.

Embodiment 24 relates to the method of Embodiments 1-23, wherein the sealant composition further comprises an acid.

Embodiment 25 relates to the method of Embodiments 1-24, wherein the solidified sealant composition has a shear strength of from about 3,000 lb/100 ft2 to about 30,000 lb/100 ft2.

Embodiment 26 relates to a system for performing the method of Embodiments 1-25, the system comprising a tubular disposed in a wellbore; a pump configured to pump the sealant composition downhole through the tubular and into the subterranean formation.

Embodiment 27 relates to a system generated by the method of Embodiments 1-25, the system comprising a subterranean formation comprising the sealant composition therein.

Embodiment 28 relates to a system generated by the method of Embodiments 1-25, the system comprising a subterranean formation comprising the solidified sealant composition therein.

Embodiment 29 relates to a method of treating a subterranean formation, the method comprising placing a sealant composition comprising an alkali-swellable latex and a viscosifying agent in a subterranean formation; and heating the sealant composition at a temperature and for a time sufficient to solidify the treatment fluid.

Embodiment 30 relates to a sealant composition for treatment of a subterranean formation, the composition comprising an alkali-swellable latex and a viscosifying agent, wherein the sealant composition solidifies upon sufficient heating.

Embodiment 31 relates to a method for solidifying a sealant composition comprising an alkali-swellable latex and a viscosifying agent, in the absence of an added pH-increasing material, comprising heating the sealant composition at a temperature and for a time sufficient to solidify the sealant composition.

What is claimed is:

1. A method comprising:
obtaining or providing a sealant composition comprising an alkali-swellable latex and a viscosifying agent;
placing the sealant composition in a subterranean formation; and
heating the sealant composition at a temperature and for a time sufficient to solidify the sealant composition.

2. The method of claim 1, wherein the sealant composition does not comprise an added pH-increasing material.

3. The method of claim 1, wherein the heating comprises heating the placed sealant composition at a temperature from about 120° F. to about 300° F.

4. The method of claim 1, wherein the time sufficient to solidify the sealant composition is from about 30 minutes to about 20 hours.

5. The method of claim 1, wherein the alkali-swellable latex comprises an ethylenically unsaturated monomer containing at least one carboxylic acid functional group.

6. The method of claim 5, wherein the ethylenically unsaturated monomer containing at least one carboxylic functional group is present in the sealant composition in the amount of from about 5 to about 30% by weight of the monomers used in preparing the alkali-swellable latex.

7. The method of claim 1, wherein the alkali-swellable latex comprises a vinyl aromatic monomer, an ethylene monomer, a butadiene monomer, a vinylnitrile monomer, an olefinically unsaturated ester of C₁-C₈ alcohol monomer, or combinations thereof.

8. The method of claim 1, wherein the alkali-swellable latex comprises hydrophobically-modified carboxylated styrene-butadiene copolymer.

9. The method of claim 1, wherein the alkali-swellable latex comprises from about 0.1 to about 5 wt. % of a crosslinking agent by weight of monomer.

10. The method of claim 1, wherein the viscosifying agent comprises at least one of alginate, chitosan, curdlan, dextran, emulsan, a galactoglucopolysaccharide, gellan, glucuronan, N-acetyl-heparosan, hyaluronic acid, indicant, kefiran, lentinan, levan, mauran, pullulan, scleroglucan, schizophyllan, stewartan, succinoglycan, xanthan gum, xylane, welan, starch, tamarind, tragacanth, guar gum, derivatized guar, gum ghatti, gum arabic, locust bean gum, diutan gum, cellulose, hydroxyethylcellulose, hemicellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

11. The method of claim 1, wherein the sealant composition further comprises a pH-increasing material.

12. The method of claim 11, wherein the pH-increasing material comprises at least one of a base-producing material and a cement.

13. The method of claim 12, wherein the cement comprises a Portland cement, a pozzolana cement, a gypsum cement, a phosphate cement, a high alumina content cement, a silica cement, a high alkalinity cement, a magnesia cement, or combinations thereof.

14. The method of claim 12, wherein the pH-increasing material comprises a base-producing material, and wherein the base-producing material comprises alkali and alkali earth metal carbonates, alkali and alkali earth metal bicarbonates, alkali and alkali earth metal hydroxides, alkali and alkali earth metal oxides, alkali and alkali earth metal phosphates, alkali and alkali earth metal hydrogen phosphates, alkali and alkaline earth metal sulphides, alkali and alkaline earth metal salts of silicates, alkali and alkaline earth metal salts of aluminates, water soluble or water dispersible organic amines, polymeric amines, amino alcohols, or combinations thereof.

15. The method of claim 11, wherein the pH-increasing material comprises an encapsulated pH-increasing material.

16. The method of claim 1, wherein the sealant composition further comprises at least one of a fluid absorbing material, a particulate material, and a non-alkali-swellable latex.

17. The method of claim 1, wherein the sealant composition further comprises a fluid absorbing material, and wherein the fluid absorbing material comprises organophilic clay, water swellable clay, a water absorbing mineral, an oil absorbing mineral, or combinations thereof.

18. The method of claim 1, wherein the sealant composition further comprises a particulate material comprising cellulosic fibers.

19. The method of claim 1, wherein the sealant composition further comprises particulate materials in an amount between about 0.01 ppb to about 200 ppb of the sealant composition.

20. The method of claim 1, wherein the sealant composition further comprises at least one of a surfactant, a densifying material, a light weight additive, fly ash, fumed silica, a defoamer, a set retarder, and a set accelerator.

21. The method of claim 1, further comprising introducing a particulate material to the wellbore.

22. The method of claim 1, wherein the method comprises mixing the alkali-swellable latex and the viscosifying agent before the placing in the subterranean formation.

23. The method of claim 1, wherein the method comprises separately placing the alkali-swellable latex and the viscosifying agent in the subterranean formation.

24. The method of claim 1, wherein the sealant composition further comprises an acid.

25. The method of claim 1, wherein the solidified sealant composition has a shear strength of from about 3,000 lb/100 ft² to about 30,000 lb/100 ft².

26. A system for performing the method of claim 1, the system comprising:
a tubular disposed in a wellbore;
a pump configured to pump the sealant composition downhole through the tubular and into the subterranean formation.

27. A system generated by the method of claim 1, the system comprising:
a subterranean formation comprising the sealant composition therein.

28. A system generated by the method of claim 1, the system comprising:
a subterranean formation comprising the solidified sealant composition therein.

29. A method of treating a subterranean formation, the method comprising:
placing a sealant composition comprising an alkali-swellable latex and a viscosifying agent in a subterranean formation; and
heating the sealant composition at a temperature and for a time sufficient to solidify the treatment fluid.

30. A sealant composition for treatment of a subterranean formation, the composition comprising an alkali-swellable latex and a viscosifying agent, wherein the sealant composition solidifies upon sufficient heating.

31. A method for solidifying a sealant composition comprising an alkali-swellable latex and a viscosifying agent, in the absence of an added pH-increasing material, comprising heating the sealant composition at a temperature and for a time sufficient to solidify the sealant composition.
